(19) United States
(12) Patent Application Publication
(10) Pub. No.: US 2006/0168839 A1
(43) Pub. Date: Aug. 3, 2006

(54) Baking method and baking apparatus for performing the same

(76) Inventors: Ju-Won Lee, Yongin-si (KR); Jae-Hyun Sung, Osan-si (KR); Nak-Hee Seong, Hwaseong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/327,361

(22) Filed: Jan. 9, 2006

(30) Foreign Application Priority Data
Jan. 19, 2005 (KR) 2005-0004968

(51) Int. Cl. F26B 13/30; F26B 5/04

(52) U.S. Cl. 34/92; 34/410

(57) ABSTRACT

A layer on a semiconductor substrate is scanned with a stream of heated gas to bake the layer. A baking apparatus includes a stage that supports the semiconductor substrate and a gas injector that expels the stream of the heated gas. The stage and the gas injector are moved relative to one another to scan the substrate with the stream of heated gas and thus, bake the layer that is disposed thereon. Fumes emanating from the layer are removed while the layer is scanned. To this end, the apparatus also includes a vacuum head that is fixed in position relative to the gas injector.

### BACKGROUND OF THE INVENTION

1. Field of the Invention

The present invention relates to the use of phototresist for forming a pattern on a substrate, such as semiconductor substrate. More particularly, the present invention relates to a method of and apparatus for baking a substrate, such as a silicon wafer, on which a layer of photoresist has been formed.

2. Description of the Related Art

In general, semiconductor devices are manufactured by fabricating electrical circuitry on a semiconductor substrate such as a silicon wafer, subsequently performing an electrical die sorting (EDS) process for testing electrical characteristics of the circuitry, separating the wafer into individual chips, and then packaging the chips using an epoxy resin.

The fabricating of the circuitry includes a deposition process of forming a layer on the wafer, a chemical mechanical polishing process of planarizing the layer, a photolithography process of forming a photoresist pattern on the layer, an etching process of patterning the layer using the photoresist pattern as a mask, an implantation process of implanting ions into designated areas of the wafer, a cleaning process of removing particles from the wafer, a drying process of drying the wafer after the cleaning process, and a testing process for detecting defects of the layer before and after it is patterned.

The photolithography process may include a coating process, a soft bake process, an exposure process, a post-exposure bake process, a developing process and a hard-bake process. The coating process entails coating a semiconductor substrate with a photoresist composition to form a photoresist layer on the semiconductor substrate. The soft bake process is performed to volatilize a solvent of the photoresist composition. In the exposure process, the photoresist layer is selectively exposed to light so that portions of the photoresist layer undergo a photochemical reaction. The post-exposure bake (PEB) process is performed after the exposure process to reduce defects due to the scattering of light in the exposure process. For example, if left unchecked, the scattering of light in the exposure process would prevent the photoresist pattern from acquiring the desired profile. Next, the developing of the photoresist layer removes selected portions of the photoresist layer so that the photoresist pattern is formed. The hard-bake process is then performed to harden the patterned photoresist layer.

The semiconductor substrate is heated during a bake process such as the soft-bake process, the PEB process or the hard-bake process. In particular, the semiconductor substrate is typically subjected to temperatures of about 80° C. to about 120° C. in the soft bake process. The semiconductor substrate is subjected to temperatures of about 80° C. to about 150° C. in the PEB process. And, the semiconductor substrate is subjected to temperatures of about 150° C. to about 200° C. in the hard-bake process.

FIG. 1 is a sectional view of a conventional baking apparatus 100 for performing a bake process. Referring to FIG. 1, the conventional baking apparatus 100 includes a chamber 102, a hot plate 104 and a cover 106. An upper portion of the chamber 102 is open. The hot plate 104 is provided in the chamber 102. The cover 106 seals the upper portion of the chamber 102. Although not illustrated in FIG. 1, a heater is connected to the hot plate 104 to transfer thermal energy to the hot plate 104 such that a semiconductor substrate disposed on the hot plate 104 is baked. In FIG. 1, reference numeral 20 designates the photoresist coating the semiconductor substrate 10, i.e., either a complete layer of photoresist or a photoresist pattern.

The heater may be a resistive wire. In this case, the wire is embedded in the hot plate 104. In addition, the wire may have a spiral shape in the hot plate 104. In any case, temperature distribution at the surface of the hot plate 104 depends, in part, on the disposition of the resistive wire within the hot plate 104. Thus, the photoresist 20 on the semiconductor substrate 10 is heated irregularly if the resistive wire is not disposed properly within the hot plate 104.

In addition, in the bake process, solvent in the photoresist 20 may be volatilized. The resultant fumes are exhausted through the cover 106. To this end, the cover 106 has exhaust holes extending therethrough and through which the fumes are discharged. However, byproducts from the fumes solidify and attach to the cover 106 after a certain number of the bake processes are performed. The solid byproducts eventually flake off of the cover 106. The resulting particles may contaminate the photoresist 20 during the bake process.

### SUMMARY OF THE INVENTION

Objects of the present invention include providing a method of and apparatus for uniformly baking a layer on a substrate such as a semiconductor substrate.

Other objects of the present invention include providing a method of and apparatus for rapidly baking a layer on a substrate such as a semiconductor substrate.

Further objects of the present invention include providing a method of and apparatus for baking a layer on a substrate, such as a semiconductor substrate, without allowing byproducts of the baking process to contaminant the processing (working) environment.

Additional objects of the present invention include providing a method of and apparatus for uniformly and/or rapidly baking several of such layers in sequence and to prevent byproducts of the baking process from becoming contaminants.

In accordance with one aspect of the present invention, there is provided a method in which a substrate is scanned with a stream of heated gas to bake a layer disposed on the substrate, and fumes emanating from the layer are removed from the processing environment. The fumes are removed by suction. Preferably, the fumes are removed at the same time that the substrate is being scanned.

That is, the semiconductor substrate and a stream of a heated gas are moved relative to each other to bake the layer with the heated gas. A stream of suction is formed adjacent to the stream of heated gas to remove fumes generated from the layer while the semiconductor substrate is being scanned with the stream of heated gas.

The heated gas may be pure air, nitrogen, argon or helium or may comprise a combination of these gases. The gas is preferably heated to a temperature of about 80° C. to about 200° C. Thus, the method is well-suited to baking a photoresist layer formed by coating the semiconductor substrate with a photoresist composition, an exposed photoresist layer or a patterned photoresist layer.

In accordance with another aspect of the present invention, there is provided a baking method in which a first substrate is set on a stage in a processing environment, a layer on the first substrate is scanned with at least one stream of heated gas by moving the stage and the at least one stream of heated gas relative to one another in a first direction, fumes emanating from the layer on the first substrate are removed from the processing environment while the layer is being baked, the first substrate is then removed from the stage and a second substrate is set on the stage, a layer on the second substrate is scanned with at least one stream of heated gas by moving the stage and the stream of heated gas relative to one another back in a second direction opposite to the first direction, and fumes emanating from the layer on the second substrate are removed from the processing environment as the layer is being baked.

In accordance with yet another aspect of the present invention, there is provided a baking apparatus that includes a stage, a gas injector movable relative to the stage, and a vacuum head. The gas injector is oriented to expel a stream of heated gas onto a layer on a substrate supported by the stage. The vacuum head extracts fumes emanating from the layer.

Preferably, the gas injector is disposed over the stage and extends longitudinally in a first horizontal direction. The gas injector is movable relative to the stage in a second horizontal direction substantially perpendicular to the first horizontal direction. The gas injector includes an injection nozzle that expels the heated gas as a stream. The injection nozzle has an opening in the form of a slit so that the stream of heated gas forms a curtain. The slit extends in the first horizontal direction. The vacuum head extends parallel to the gas injector. Preferably, the vacuum head is fixed in position relative to the gas injector. Thus, in the case in which the gas injector is supported so as to be movable, the vacuum head is moved together with the gas injector. On the other hand, in the case in which the gas injector is fixed in place in the apparatus, the suction member is also fixed in place.

The baking apparatus also includes a gas supply section connected to the gas injector to supply the heated gas to the gas injector. The gas supply section includes a storage container, a gas supply pipe, a heater and a flow control valve. The storage container stores the gas. The gas supply pipe connects the storage container and the gas injector. The heater heats the gas flowing through the gas supply pipe. The flow control valve regulates the rate at which the heated gas flows to the gas injector.

The baking apparatus also includes a vacuum exhaust system connected to the vacuum head. The vacuum exhaust system includes a vacuum pump, a vacuum pipe and a pressure regulating valve. The vacuum pump creates a vacuum. The vacuum pipe connects the vacuum head and the vacuum pump. The pressure regulating valve is disposed in-line with the vacuum pipe.

The baking apparatus also includes a stage, and a driving mechanism for moving the stage and the gas injector relative to one another. The stage supports the substrate on which the layer to be baked is disposed. The upper surface of the stage against which the substrate rests is horizontal. The driving mechanism moves either the stage or the gas injector horizontally. That is, the gas injector and the vacuum head are connected to and driven by the driving mechanism. Alternatively, the stage is connected to and driven by the driving mechanism.

Also, according to the present invention, the heated gas may be produced as a stream flowing vertically in a downward direction, i.e., substantially perpendicular to the substrate and the upper surface of the stage against which the substrate rests. In this case, first and second streams of suction may be generated as flowing vertically in an upward direction, i.e., as also substantially perpendicular to the substrate and the upper surface of the stage against which the substrate rests. Alternatively, the first and second streams of suction may be generated to flow along respective axes each of which intersects the semiconductor substrate and the upper surface of the stage at an acute angle. In this case, the first and second axes are preferably symmetrical about an axis that extends substantially perpendicular to the upper surface of the stage.

Still further, according to the present invention, a first stream of heated gas and a second stream of heated gas can be used to bake the layer. In this case, a single stream of suction is generated to flow in a direction perpendicular to the upper surface of the stage, and the first and second streams of heated gas extend along first and second axes each of which intersects the semiconductor substrate and the upper surface of the stage at an acute angle. Preferably, the first and second axes are substantially symmetrical about the suction stream.

Also, according to the present invention, a stream of the heated gas may be produced to flow along a first axis that intersects the semiconductor substrate and the upper surface of the stage at an acute angle. The stream of suction is generated to flow along a second axis that also intersects the semiconductor substrate and the upper surface of the stage at an acute angle. The first axis and the second axis are substantially symmetrical about an axis that extends substantially perpendicular to the semiconductor substrate.

Thus, according to the present invention, the layer on a semiconductor substrate is scanned with at least one stream of heated gas so that the layer may be uniformly and rapidly baked. In addition, fumes emanating from the layer are immediately removed from the processing environments. Thus, the baking process ensures uniformity in the layer. In addition, byproducts of the baking process are prevented from polluting the processing environment.

### BRIEF DESCRIPTION OF THE DRAWINGS

The above and other objects, features and advantages of the present invention will become readily apparent by reference to the following detailed description of the preferred embodiments thereof made in conjunction with the accompanying drawings in which:

FIG. 1 is a sectional view of a conventional baking apparatus;

FIG. 2 is a flow chart of a general method of baking a semiconductor substrate in accordance with the present invention;

FIG. 3 is side view, partially in section, of a baking apparatus in accordance with the present invention;

FIG. 4 is a perspective view of the baking apparatus shown in FIG. 3;

FIG. 5 is a longitudinal sectional view of the gas injector of the baking apparatus;

FIG. 6 is a schematic diagram of a gas supply section and a vacuum system of the baking apparatus shown in FIG. 3;

FIG. 7 is a side view, partially in section and partially schematic, of another embodiment of a baking apparatus in accordance with the present invention;

FIG. 8 is a side view, partially in section, of still another embodiment of a baking apparatus in accordance with the present invention;

FIG. 9 is a side view, partially in section, of another embodiment of a baking apparatus in accordance with the present invention;

FIG. 10 is a side view, partially in section, of yet another embodiment of a baking apparatus in accordance with the present invention; and

FIG. 11 is a side view, partially in section, of yet another embodiment of a baking apparatus in accordance with the present invention.

### DETAILED DESCRIPTION OF THE PREFERED EMBODIMENTS

The present invention will now be described in more detail with respect to the accompanying drawings. However, the drawings are not to scale. Also, when a layer is described as being disposed “on” a substrate or another layer, such a description may refer to either a case in which the layer is situated directly on the substrate or the other layer or the case in which another layer(s) is/are interposed therebetween.

Furthermore, the present invention may be employed in the practice of baking a coated substrate and, in particular, a semiconductor substrate such as a silicon wafer. The coated substrate may be a semiconductor substrate having an unexposed layer of photoresist thereon, a semiconductor substrate having an exposed layer of photoresist thereon, or a semiconductor substrate having a patterned photoresist layer thereon. That is, the present invention may be employed in a soft-bake process, a post-exposure bake (PEB) process or a hard-bake process.

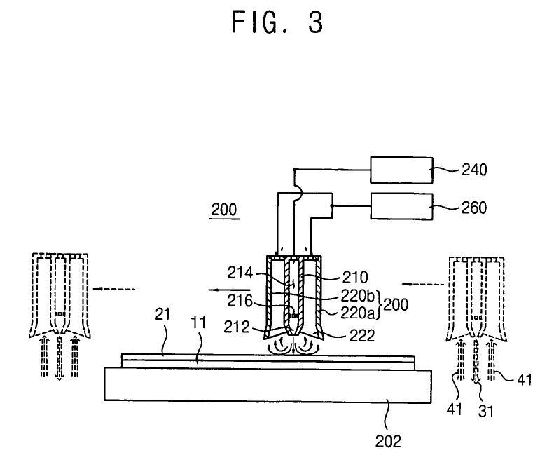

Referring first to FIG. 3, a baking apparatus 200 according to the present invention includes a stage 202 disposed in a processing environment such as that created in a chamber, a gas injector 210 and a vacuum head 220 including at least one suction member. The stage 202 supports a semiconductor substrate 11 on which a layer 21 comprising photoresist is disposed. The gas injector 210 injects the heated gas onto the layer 21. The vacuum head 220 extracts fumes emanating from the layer 21.

More specifically, the stage 202 may have the shape of a disk whose upper surface is horizontal. The semiconductor substrate 11 is supported on the stage 202. Lift pins (not shown) load the semiconductor substrate 11 onto the stage 202. The lift pins extend freely through the stage 202 so that the lift pins may be vertically movable. The stage 202 may simply support the semiconductor substrate 11. Alternatively, the stage 202 may incorporate a mechanism by which the semiconductor substrate 11 is held thereto. For example, the stage 202 may comprise a vacuum chuck that holds the semiconductor substrate 11 using suction. As another example, the stage 202 may comprise an electrostatic chuck that holds the semiconductor substrate 11 using an electrostatic force.

The gas injector 210 is situated above the stage 202. The gas injector 210 is movable relative to the stage 202 so that the layer 21 on the substrate 21 can be scanned with heated gas expelled by the gas injector 210. That is, as illustrated in FIG. 3, the stage 202 may be stationary, and the gas injector 210 may be movable over the stage 202. Alternatively, the gas injector 210 may be stationary, and the stage 202 may be movable under the gas injector 210. A driving mechanism connected to the gas injector 201 or the stage 202 provides the relative movement between the gas injector 210 and the stage 202.

The vacuum head 220 is fixed in position relative to the gas injector 210. For example, the vacuum head 220 may be fixed directly to the gas injector 210. Thus, in the case in which the gas injector 210 is movable, the vacuum head 220 is movable together with the gas injector 210. On the other hand, in the case in which the stage 202 is movable, the vacuum head 220 is stationary together with the gas injector 210. As is also illustrated in FIG. 3, a pair of the suction members 220a, 220b may be fixed to opposite sides of the gas injector 210 to extract the fumes emanating from the layer 21.

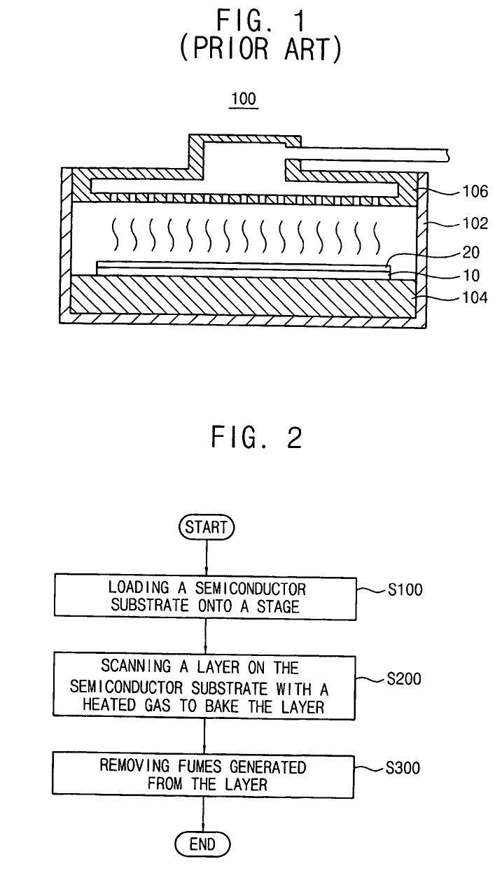

A general method of baking the layer 21 disposed on the semiconductor substrate 11 will now be described with reference to FIGS. 2 and 3.

First, the semiconductor substrate 11 on which the layer 21 is formed is loaded onto the stage 202 (step S100). During this time, the gas injector 210 and the suction member 220 may be laterally spaced from the stage 202, i.e., may be spaced from the stage 202 in a horizontal direction. Thus, the gas injector 210 and the suction member 220 may avoid interfering with the loading of the semiconductor substrate 11 onto the stage 202.

Next (step S200), the layer 21 on the semiconductor substrate 11 is scanned with the heated gas expelled as a stream 31 from the gas injector 210 so that the layer 21 may be baked. The stream 31 of heated gas may have a shape designed to minimize the time required for baking the layer 21. For example, the stream 31 of heated gas may have a width substantially larger than that of the semiconductor substrate 11. Thus, in the case in which the semiconductor substrate 11 is a silicon wafer, the stream 31 of the heated gas expelled by the gas injector 210 has a width substantially larger than the diameter of the silicon wafer.

Also, the stream 31 may be expelled from the gas injector 210 in various directions relative to the semiconductor substrate 11. For example, the stream 31 may be expelled substantially perpendicular to the semiconductor substrate 11. In this case, the semiconductor substrate 11 and the gas injector 210 may be oriented horizontally and vertically, respectively. Alternatively, the stream 31 may be directed at an acute angle relative to (the upper surface of) the semiconductor substrate 11. In this case, the gas injector 210 may be oriented at an acute angle with respect to the upper surface of the semiconductor substrate 11.

In the embodiment illustrated in FIG. 3, the gas injector 210 is moved over the stage 202 while the stage 202 remains stationary. Specifically, the gas injector 210 is moved horizontally across the semiconductor substrate 11 so that the stream 31 of heated gas expelled from the gas injector 210 impinges the layer 21 disposed on the semiconductor substrate 11. Thus, the layer 21 is uniformly baked. Alternatively, the stage 202 may be moved horizontally under the gas injector 210 while the gas injector 210 remains stationary.

The heated gas may be pure air, nitrogen (N₂), argon (Ar) or helium (He). These gases may be used alone or in combination. The temperature of the heated gas may be at about 80° C. to about 200° C. In particular, in the case in which the layer 21 is an unexposed photoresist layer on the semiconductor substrate 11, the temperature of the heated gas is preferably in a range of about 80° C. to about 120° C. In the case in which the layer 21 is an exposed photoresist layer, the temperature of the heated gas is preferably within a range of about 80° C. to about 150° C. In the case in which the layer 21 is a patterned photoresist layer, the temperature of the heated gas is preferably in a range of about 150° C. to about 200° C.

Finally (step S300), the fumes emanating from the layer 21 are removed during the baking process. The fumes may be gaseous solvents volatilized from the layer 21. The fumes may be entrained in a suction stream 41 generated adjacent to the injection stream 31. As illustrated in FIG. 3, the direction in which the suction stream 41 flows may be substantially opposite to the direction in which the stream 31 of heated gas is generated. In particular, the injection stream 31 may flow vertically in a downward direction, whereas the suction stream 41 may flow vertically in an upward direction.

In any case, the fumes are removed as soon as the fumes are generated because the suction stream 41 is formed adjacent to the injection stream 31. In addition, the end of the vacuum head 220 may be positioned adjacent to the layer 21 so that the fumes are removed as soon as the fumes are generated. For example, the end of the vacuum head 220 may be spaced by a distance of about 5 mm to about 50 mm from the layer 21. Thus, hardly any solid byproducts of the baking process are formed on a cover sealing an upper portion of the process chamber in which the layer 21 is baked.

As described above, the suction stream(s) 41 may be created vertically, i.e., perpendicular to the substrate 11. Alternatively, the suction stream(s) 41 may be created at an acute angle(s) with respect to the semiconductor substrate 11. According to one embodiment of the present invention, the first suction member 220a and the second suction member 220b are oriented at acute angles with respect to the upper surface of the stage 202. However, in the following description, reference instead will be made to the semiconductor substrate 11 as the reference plane. Preferably, in this case, the first suction member 220a and the second suction member 220b are oriented substantially symmetrically with respect to the gas injector 210.

Also, in another embodiment, an injection stream 31 and a suction stream 41 are formed at respective angles with respect to the semiconductor substrate 11. That is, in this case, the gas injector 210 is oriented over the semiconductor substrate 11 along a first axis that subtends an acute angle with the semiconductor substrate 11. The vacuum head 220, on the other hand, is oriented over the semiconductor substrate 11 along a second axis that subtends an acute angle with the semiconductor substrate 11. The first axis and the second axis may be substantially symmetrical with respect to an axis that extends substantially perpendicular to the semiconductor substrate 11.

As described above, the layer 21 may be baked by moving the gas injector 210 and the stage 202 relative to each other so that the so that the substrate 11 is scanned once across by the heated gas expelled by the gas injector 210. At this time, various parameters of the process are controlled according to the thickness and composition of the layer 21 being baked. The parameters include the speed of the scan, the flow rate of the heated gas, etc.

After the layer 21 on the semiconductor substrate 11 is baked, the substrate 11 is removed from the process chamber and a subsequent semiconductor substrate is loaded onto the stage 202. When the layer on this subsequent substrate is baked, the gas injector 210 may be moved relative to the stage 202 in a direction substantially opposite to that during the baking of the layer 21 on the previous semiconductor substrate 11.

One specific embodiment of the baking apparatus according to the present invention will now be described with reference to FIGS. 3 to 5. In this embodiment, the gas injector 210 extends in a first horizontal direction over a distance greater than the width (diameter) of the substrate 11 that is to be baked. Specifically, the gas injector 210 has a length that is substantially equal to or greater than the width of the stage 202. The gas injector 210 is movable in a second horizontal direction and a third horizontal direction that are substantially perpendicular to the first horizontal direction. In particular, the gas injector 210 is connected to a driving mechanism 230 by which the gas injector can be reciprocated.

The driving mechanism 230 may be a robot having a horizontal transfer portion 232 and a vertical transfer portion 234. The gas injector 210 is connected to the vertical transfer portion 234 by bolts or the like. The horizontal transfer portion 232 drives the gas injector 210 in the second or third horizontal direction, and the vertical transfer portion 234 drives the gas injector 210 vertically. That is, the vertical transfer portion 234 controls the height of the gas injector 210 so that the distance between the gas injector 210 and the layer 21 on the semiconductor substrate 11 may be adjusted.

The lower end of the gas injector 210 may be formed as an injection nozzle 212, e.g., is tapered such that the cross-sectional area of the injection nozzle 212 decreases in a direction towards the stage 202. The injection nozzle 212 thus defines a slit through which the heated gas is expelled, whereby the injection stream 31 is in the form of a curtain. Also, the gas injector 210 has a plenum 214 in which the heated gas supplied from the gas supply 240 is stored before being expelled towards the substrate 11. To this end, the gas injector 210 has a horizontally extending baffle plate 216 that partitions the interior of the gas injector 210 into the plenum 214 and the injection nozzle 212. The baffle plate 216 also has a plurality of through-holes through which the heated gas flows so as to be expelled from the gas injector 210 at a substantially uniform flow rate.

The first and second suction members 220a and 220b extend parallel to the gas injector 210 on opposite sides of and adjacent to the gas injector 210. That is, the first and second suction members 220a and 220b extend in the first horizontal direction. Each suction member 220a, 220b has a suction nozzle 222 at the lower end thereof. The suction nozzle 222 is flared. That is, the cross-sectional area of the suction nozzle 222 increases in a direction towards the stage 202. In addition, the suction members 220a, 220b are connected to the vertical transfer portion 234 along with the gas injector 210. Thus, the suction members 220a, 220b are driven horizontally by the horizontal transfer portion 232 and vertically by the vertical transfer portion 234 of the robot.

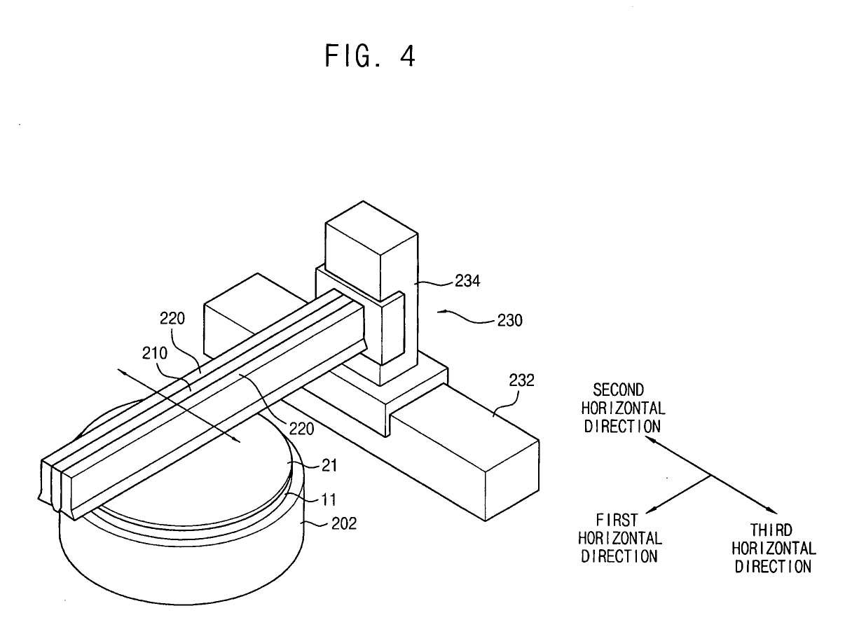

As an alternative to the embodiment illustrated in FIG. 4, the driving mechanism 230 may comprise a single axis robot that is movable only horizontally, i.e., in the second and third horizontal directions. In this case, a mechanism is provided so that the distance between the gas injector 210 and the stage 202 and hence, between the gas injector 210 and the layer 21 on a substrate 11 supported by the stage 202, can be manually adjusted.

Referring to FIG. 6, a gas supply section 240 is connected to an upper portion of the gas injector 210 to supply the heated gas into the plenum 214. The gas supply section 240 includes a container 242, a gas supply pipe 244, a heater 246 and a first valve 248. The container 242 stores gas. The gas supply pipe 244 extends between the container 242 and the gas injector 210. The heater 246 heats the gas flowing through the gas supply pipe 244. The first valve 248 controls the flow rate of the heated gas.

The gas supply section 240 may further include filters disposed in the gas supply line 244 between the container 242 and the heater 246. The filters remove impurities from the gas. For example, a first filter 250, a second filter 252 and a third filter 254 may be interposed between the container 242 and the heater 246. In this case, the first filter 250 removes particles from the gas, the second filter 252 removes moisture from the gas, and the third filter 254 removes volatile organic compounds (VOC) from the gas. More specifically, the first filter 250 may be a high-efficiency particulate air (HEPA) filter or an ultra-low penetration air (ULPA) filter. The second filter 252 may be a moisture purifier such as a molecular sieve moisture purifier. The third filter 254 may be an activated carbon filter.

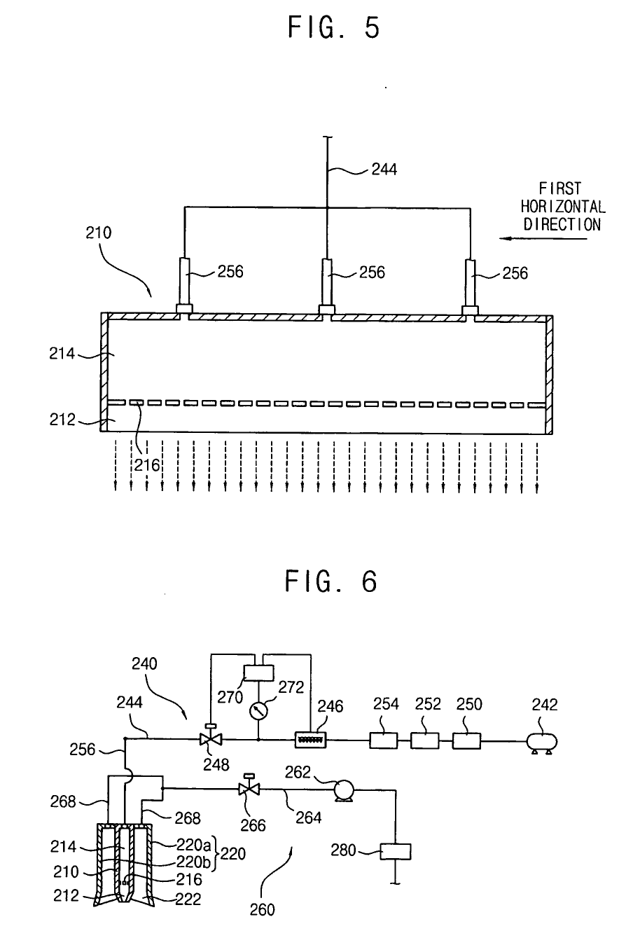

As illustrated in FIG. 5, the gas supply section 240 may further include first pipes 256 branched from the gas supply pipe 244. The first pipes 256 are arrayed along the first horizontal direction in which the gas injector 210 extends and are connected to the gas injector 210. In particular, the first pipes 256 are connected to an upper portion of the gas injector 210 as spaced apart from one another at substantially equal intervals.

The vacuum exhaust system 260 includes a vacuum pump 262, a vacuum pipe 264 and a second valve 266. The vacuum pump 262 generates a vacuum used for removing the fumes. The vacuum pipe 264 extends between and connects the vacuum head 220 and the pump 262. The second valve 266 is disposed in the vacuum pipe 264. The vacuum exhaust system 260 may further include a gas scrubber 280 connected to the vacuum pump 262 so that the exhaust gas including the fumes may be purified.

In addition, the vacuum exhaust system 260 may include second pipes 268 branched from the vacuum pipe 264. The second pipes 268 are arrayed in the first horizontal direction along the vacuum head 220. In particular, the second pipes 268 are spaced from one another along an upper portion of the vacuum head 220 at equal intervals. The second pipes 268 thus serve to maintain the vacuum pressure substantially constant in the vacuum head 220.

Furthermore, although the lower end portion of the vacuum head 220 has been shown and described as being flared whereas the lower end portion of the gas injector 210 has been shown and described as being tapered, the lower end portions of the gas injector 210 and the vacuum head 220 may both be flared so that the flow rate of the heated gas and the vacuum pressure are kept substantially constant. That is, the cross-sectional areas of the lower end portions of the gas injector 210 and the vacuum head 220 increase in a direction towards the stage 202. In this case, the flow rate of the heated gas and the vacuum pressure are kept substantially constant without the need for the first pipes 256 and the second pipes 268. Therefore, the gas supply pipe 244 and the vacuum pipe 264 may be directly connected to the gas injector 210 and the vacuum head 220, respectively.

The baking apparatus 200 may further include a controller 270 and a temperature sensor 272. Preferably, the controller 270 controls the flow rate and temperature of the heated gas. More specifically, the temperature sensor 272 is connected to the gas supply pipe 244 and the controller 270 to measure the temperature of the heated gas flowing through the gas supply pipe 24 and to issue a signal representative of the measured temperature to the controller 270. The controller 270 is also connected to the heater 246 to control the operation of the heater 246 and hence, the temperature of the heated gas, on the basis of the temperature measured by the temperature sensor 272. The controller 270 is also connected to the first valve 248 to control the degree to which the first valve 248 is open and thereby adjust the flow rate of the heated gas. In addition, the controller 270 may be connected to the driving mechanism 230 such that the controller 270 controls the speed at which the gas injector 210 and the vacuum head 220 are moved relative to the stage 202 as well as the interval between the gas injector 210 and the layer 21 on the semiconductor substrate 11.

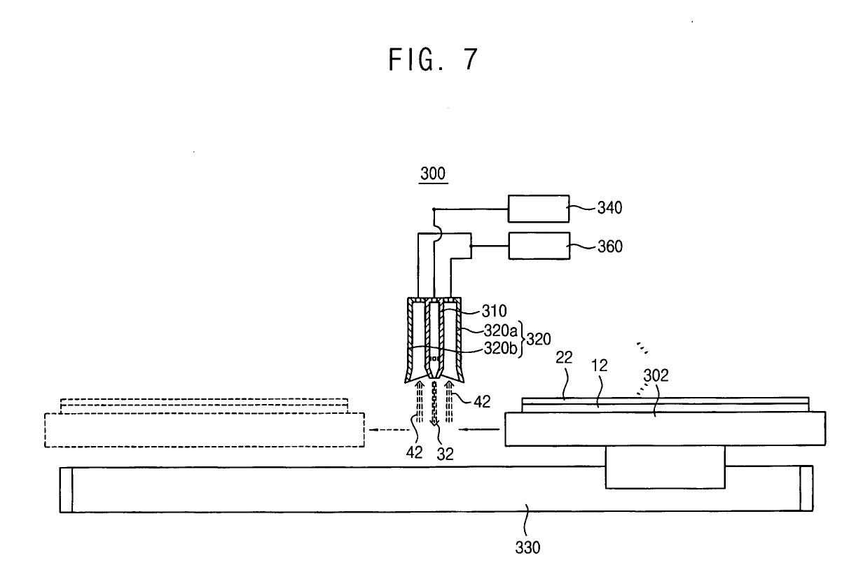

FIG. 7 illustrates an embodiment of a baking apparatus 300 according to the present invention in which the gas injector and suction member remain stationary. Referring to FIG. 7, the baking apparatus 300 includes a stage 302, a gas injector 310, a vacuum head 320 and a driving mechanism 330. The stage 302 supports a semiconductor substrate 12 on which a layer 22 has been formed. The gas injector 310 expels a stream 32 of heated gas to bake the layer 22 on the semiconductor substrate 12. The vacuum head 320 generates a suction stream 42 that removes fumes emanating from the layer 22. The vacuum head 320 may comprise two suction members 320a, 320b fixed to opposite sides of the gas injector 320 for generating suction streams 42 on opposite sides of the injection stream 32. The driving mechanism 330 is connected to the stage 302 so as to move the stage horizontally beneath the gas injector 310. Thus, the layer 22 on the semiconductor substrate 12 may be scanned with a stream 32 of heated gas expelled from the gas injector 310. In addition, the baking apparatus 300 further includes a gas supply section 340 and a vacuum exhaust system 360. The gas supply section 340 is connected to the gas injector 310. The vacuum exhaust system 360 is connected to the vacuum head 320.

The driving mechanism 330 may be a single axis robot capable of reciprocating the stage 302 along a horizontal axis. The gas injector 310 and the vacuum head 320 extend horizontally from and are supported by a vertical support (not shown) of the driving mechanism 330. The spacing between the layer 22 on the semiconductor substrate 12 and the gas injector 310 may be set by the position at which the gas injector 310 is supported. Alternatively, the baking apparatus 300 may further include a mechanism (manual or automatic) by which the height of the gas injector 310 and the vacuum head 320 may be adjusted.

The other elements of the baking apparatus 300, i.e., those other than the driving mechanism 330, are substantially the same as those of the baking apparatus 200 of the embodiments of FIGS. 3 to 5. For instance, the baking apparatus 300 also includes a controller. The controller may control the flow rate of the heated gas, the temperature of the heated gas and the speed at which the stage 302 is moved by the driving mechanism 330, all in accordance with the composition and/or the thickness of the layer 22.

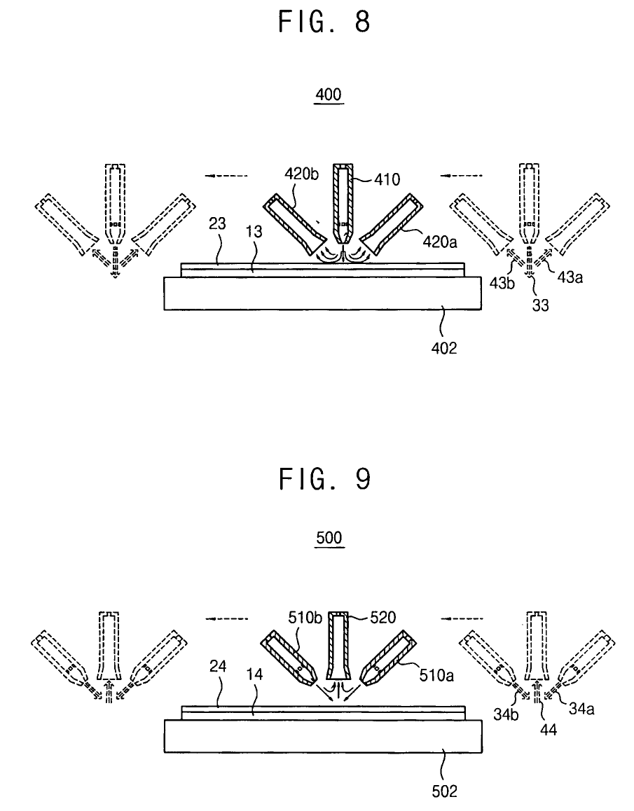

FIG. 8 illustrates embodiments of another method of and apparatus for baking a layer on a substrate in accordance with the present invention. Referring to FIG. 8, the baking apparatus 400 includes a stage 402, a gas injector 410, a first suction member 420a, a second suction member 420b, and other components, such as a driving mechanism, similar to those shown and described in connection with the previous embodiments.

As in the previous embodiments, the gas injector 410 is disposed over the stage 402 and expels a stream 33 of a heated gas. In this embodiment, the injection stream 33 of the heated gas is directed vertically downward towards a semiconductor substrate 13 supported by the stage 402. The first and second suction members 420a and 420b are disposed on opposite sides of the gas injector 410 at positions fixed relative to the gas injector 410. The first and second suction members 420a and 420b thus produce first and second suction streams 43a and 43b, respectively on opposite sides of the injection stream 33.

More specifically, the first suction member 420a extends along a first axis that subtends an acute angle with the upper surface of the stage 402 that supports the semiconductor substrate 13. The second suction member 420b extends along a second axis that also subtends an acute angle with the upper surface of the stage 402 that supports the semiconductor substrate 13. The first axis and the second axis may be substantially symmetric with respect to the gas injector 410. In any case, the first and second suction streams 43a and 43b are formed at acute angles, respectively, with respect to the semiconductor substrate 13. Also, a suction nozzle (flared end) of the suction member 420a and a suction nozzle (flared end) of the second suction member 420b are disposed adjacent the nozzle (tapered end) of the gas injector 410. The driving mechanism moves the stage 402 and the gas injector 410 relative to one another so that the semiconductor substrate 13 is scanned with the stream 33 of heated gas. In addition, the first suction member 420a and the second suction member 420b are fixed relative to the gas injector 410 and thus move relative to the stage 402 along with the gas injector 410. Thus, first and second suction streams 43a and 43b act adjacent the portion of the layer 23 onto which the heated gas is directed by the gas injector 410.

FIG. 9 illustrates embodiments of another method of and apparatus for baking a layer on a substrate in accordance with the present invention. Referring to FIG. 9, the baking apparatus 500 includes a stage 502, a first gas injector 510a, a second gas injector 510b, a vacuum head 520, and other components, such as a driving mechanism, similar to those shown and described in connection with the previous embodiments.

The first gas injector 510a and the second gas injector 510b direct a first stream 34a of heated gas and a second stream 34b of heated gas, respectively, towards a semiconductor substrate 14 supported by the stage 502. More specifically, the first gas injector 510a extends along a first axis subtending an acute angle with the upper surface of the stage 502 that supports the semiconductor substrate 14. The second gas injector 510b extends along a second axis subtending an acute angle with the upper surface of the stage 502 that supports the semiconductor substrate 14. The first axis and the second axis may be substantially symmetrical with respect to the suction member 520. In any case, the first and second injection streams 34a and 34b are thus formed at acute angles with respect to the semiconductor substrate 14. In addition, the first injection stream 34a and the second injection stream 34b may intersect at a point along the layer 24 disposed on the semiconductor substrate 14.

The vacuum head 520 is fixed in position relative to the first and second gas injectors 510a and 510b. In particular, the vacuum head 520 is interposed between the first gas injector 510a and the second gas injector 510b. The suction member 520 forms a suction stream 44 extending vertically and hence, perpendicular to the semiconductor substrate 14. The driving mechanism moves the stage 502 and the first and second gas injectors 510a and 510b relative to each other so that the layer 24 on the semiconductor substrate 14 is scanned with the first and second injection streams 510a and 510b of heated gas. Also, a suction nozzle (flared end) of the vacuum head 520 may be disposed adjacent the portion of the layer 24 at which the first and second injection streams 510a and 510b intersect. Thus, the fumes emanating from the layer 24 are removed immediately during the scan because the vacuum head 520 is fixed in position relative to the first and second gas injectors 510a and 510i b.

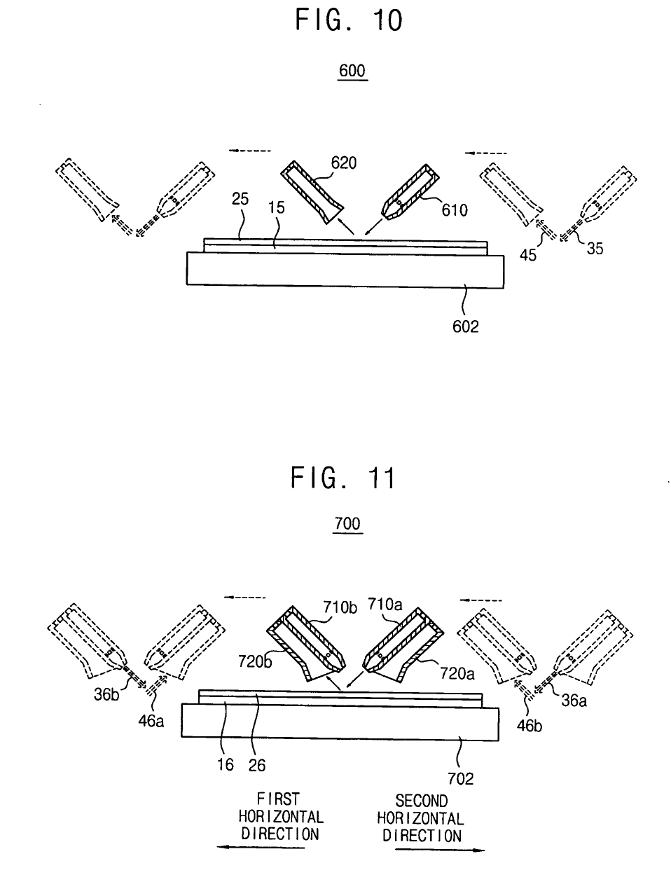

FIG. 10 illustrates another embodiment of a method of and an apparatus for baking a layer formed on a substrate in accordance with the present invention. Referring to FIG. 10, the baking apparatus 600 includes a stage 602, a gas injector 610, a vacuum head 620, and other components, such as a driving mechanism, similar to those shown and describe in connection with the previous embodiments.

The gas injector 610 directs a stream of heated gas onto a layer 25 disposed on a semiconductor substrate 15 supported by the stage 602. More specifically, the gas injector 610 extends along a first axis that subtends an acute angle with the upper surface of the stage 602 that supports the semiconductor substrate 15. Thus, the gas injector 610 forms an injection stream 35 at an acute angle relative to the semiconductor substrate 15. The vacuum head 620 extends along a second axis that subtends an acute angle with the upper surface of the stage 602 that supports the semiconductor substrate 15. Thus, the vacuum head 620 forms a suction stream 45 at an acute angle with respect to the semiconductor substrate 15. A suction nozzle (flared end) of the vacuum head 620 is disposed adjacent to a portion of the layer 25 onto which the stream 35 of heated gas is directed by the gas injector 610. The driving mechanism moves the stage 602 and the gas injector 610 relative to each other so that the layer 25 is canned with the stream 35 of heated gas. The fumes emanating from the layer 25 are immediately removed by the vacuum head 620 because the position of the suction member is fixed relative to the gas injector 610.

FIG. 11 illustrates yet another embodiment of a method of and apparatus for baking a layer on a semiconductor substrate in accordance with the present invention. Referring to FIG. 11, the baking apparatus 700 includes a stage 702, a first gas injector 710a, a second gas injector 710b, a first suction member 720a, a second suction member 720b, and other components, such as a driving mechanism, similar to those shown and described in connection with the previous embodiments.

The first and second gas injectors 710a and 720b direct first and second streams 36a and 36b of heated gas, respectively, towards a semiconductor substrate 16 supported by the stage 702. More specifically, the first gas injector 710a extends along a first axis that subtends an acute angle with the upper surface of the stage 702 on which the semiconductor substrate 16 rests. Thus, the first gas injector 710a forms a first injection stream 36a at an acute angle with respect to the semiconductor substrate 16. The second gas injector 710b extends along a second axis that subtends an acute angle with the upper surface of the stage 702 on which the semiconductor substrate 16 rests. Thus, the second gas injector 710b forms a second stream 36b at an acute angle with respect to the semiconductor substrate 16. The first axis and the second axis may be substantially symmetrical with respect to an axis substantially perpendicular to the semiconductor substrate 16.

The first and second suction members 720a and 720b are fixed in position relative to the first and second gas injectors 710a and 710b, respectively. For example, the first and second suction members 720a and 720b may be directly fixed to the first and second gas injectors 710a and 710b, respectively. Also, the first suction member 720a extends along a third axis that subtends an acute angle with the upper surface of the stage 702 on which the semiconductor substrate 16 rests. The angle subtended by the third axis and the upper surface of the stage 702 may be substantially the same as that subtended by the first axis and the upper surface of the stage 702. Thus, the first suction member 720a produces a first suction stream 46a that flows at an acute angle with respect to the semiconductor substrate 16. The second suction stream 46b extends along a fourth axis that subtends an acute angle with the upper surface of the stage 702 on which the semiconductor substrate 16 rests. The angle subtended by the fourth axis and the upper surface of the stage 702 may be substantially the same as that subtended by the second axis and the upper surface of the stage 702. Thus, the second suction member 720b forms a second suction stream 46b that flows at an acute angle with respect to the semiconductor substrate 16.

In addition, as illustrated in FIG. 11, the first and the second suction members 720a and 720a are situated under the first and second gas injectors 710a and 710b, respectively. In this case, a suction nozzle (flared end) of the first suction member 720a is disposed adjacent to a portion of the layer 26 onto which the stream 36b of heated gas is directed by the second gas injector 710b. On the other hand, a suction nozzle (flared end) of the second suction member 720b is disposed adjacent to a portion of the layer 26 onto which the stream 36a of heated gas injected is directed by the first gas injector 710a.

As is also illustrated in FIG. 11, the driving mechanism moves the stage 702 and the first and second gas injectors 710a and 710b relative to each other so that the layer 26 on the semiconductor substrate 16 is scanned with the first and second streams 36a, 36b of the heated gases. In this respect, the driving mechanism may move the first and second gas injectors 710a and 710b and the first and second suction members 720a and 720b relative to the stage 702 in a first horizontal direction to bake the layer 26 on the semiconductor substrate 16. In this case, however, only the first gas injector 710a and the second suction member 720b are used to bake the layer 26 and remove the fumes that emanate from the layer 26, respectively. On the other hand, the driving mechanism may also move the first and second gas injectors 710a and 710b and the first and second suction members 720a and 720b relative to the stage 702 in a second horizontal direction substantially opposite to the first horizontal direction. For example, the first and second gas injectors 710a and 710b and the first and second suction members 720a and 720b may be moved relative to the stage 702 in the second horizontal direction to bake a layer on a subsequent semiconductor substrate. In this case, only the second gas injector 710b and the first suction member 720a are used to bake the layer 26 and remove the fumes that emanate from the layer 26, respectively.

According to the present invention as described above, a semiconductor substrate is scanned with a stream of heated gas so that a layer disposed on the substrate may be uniformly baked. In addition, fumes emanating from the layer may be rapidly removed. Thus, a layer that has highly uniform characteristics or a desired profile may be formed through the heat treatment performed on the layer. In addition, the contamination of the substrate is prevented.

Finally, the foregoing detailed description of the preferred embodiments is merely illustrative of the present invention. That is, many modifications of the disclosed embodiments will be readily apparent to those skilled in the art. Therefore, the disclosed embodiments may be changed or modified within the true spirit and scope of the invention as defined by the following claims.

What is claimed is:

1. A method of thermally treating a layer on a substrate, comprising:
setting the substrate in position in a processing environment;
subsequently scanning the substrate with at least one stream of heated gas directed at the layer, thereby baking the layer; and
removing fumes emanating from the layer, as the result of the layer being baked, from the processing environment.

2. The method of claim 1, wherein the heated gas comprises at least one gas selected from the group consisting of pure air, nitrogen, argon and helium.

3. The method of claim 1, wherein the heated gas has a temperature of about 80° C. to about 200° C.

4. The method of claim 1, wherein the layer comprises photoresist.

5. The method of claim 1, wherein the heated gas is in the form of a curtain.

6. The method of claim 1, wherein the scanning of the layer and the removing of the fumes are performed at the same time.

7. The method of claim 1, wherein said scanning of the substrate comprises moving the substrate and the stream of heated gas relative to one another until the entire upper surface of the layer is scanned with the stream of heated gas, and
said removing of the fumes comprises suctioning away the fumes by generating a stream of suction adjacent to the stream of heated gas.

8. The method of claim 7, wherein said scanning of the substrate comprises producing a curtain of heated gas having a length that is at least equal to the width of the substrate, and moving the substrate and the curtain of heated gas relative to one another while the curtain of heated gas extends across the substrate.

9. The method of claim 7, wherein said scanning of the substrate comprises directing the stream of heated gas onto the layer on the substrate in a first direction substantially perpendicular to the substrate.

10. The method of claim 9, wherein said suctioning away of the fumes comprises generating suction as a stream flowing in a second direction substantially opposite to the first direction.

11. The method of claim 9, wherein the stream of suction is generated to flow along an axis that intersects the substrate at an acute angle.

12. The method of claim 7, wherein the stream of heated gas is produced to flow onto the substrate along a first axis that intersects the substrate at an acute angle, the stream of suction is generated to flow along a second axis that intersects the substrate at an acute angle, and the first and second axes are substantially symmetrical about an axis that extends substantially perpendicular to the substrate.

13. The method of claim 7, wherein said scanning of the substrate comprises moving the stream of heated gas while keeping the substrate stationary.

14. The method of claim 7, wherein said scanning of the substrate comprises moving the substrate while keeping the stream of heated gas flowing at a fixed location.

15. The method of claim 1, wherein said setting the substrate in position comprises loading the substrate onto a stage, and
said scanning of the substrate comprises producing the stream of heated gas by expelling heated gas from at least one nozzle, positioning the at least one nozzle to face the layer on the substrate, and moving the stage and the at least one nozzle relative to one another, and
said removing of the fumes comprises suctioning away the fumes by positioning an open end of a vacuum head adjacent the layer, producing vacuum pressure in the vacuum head, and moving the stage and the vacuum head relative to one another with the vacuum head being fixed in position relative to the at least one nozzle.

16. A thermal treatment method of processing substrates, comprising:
setting a first substrate on a stage in a processing environment, the first substrate having a layer thereon;
subsequently scanning the entirety of the layer on the first substrate with at least one stream of heated gas by only moving the stage and the at least one stream of heated gas relative to one another once in a first direction, thereby baking the layer on the first substrate;
removing fumes, emanating from the layer on the first substrate, from the processing environment as the layer is being baked;
removing the first substrate from the stage after the layer thereon has been baked;
subsequently setting a second substrate on the stage, the second substrate having a layer thereon;
subsequently scanning the entirety of the layer on the second substrate with at least one stream of heated gas by only moving the stage and the stream of heated gas relative to one another once in a second direction opposite to the first direction, thereby baking the layer on the second substrate; and
removing fumes, emanating from the layer on the second substrate, from the processing environment as the layer is being baked.

17. The method of claim 16, wherein the heated gas comprises at least one gas selected from the group consisting of pure air, nitrogen, argon and helium.

18. The method of claim 17, wherein the heated gas has a temperature of about 80° C. to about 200° C.

19. The method of claim 17, wherein the layers on the substrates each comprise photoresist.

20. The method of claim 16, wherein said scanning of the layer on the first substrate and said scanning of the layer on the second substrate each comprises directing only one stream of heated gas onto the layer along an axis substantially perpendicular to the substrate on which the layer is disposed.

21. The method of claim 21, wherein said removing of the fumes from the layer on the first substrate and said removing of the fumes from the layer on the second substrate each comprises generating suction in two streams flowing at opposite sides of the one stream of heated gas.

22. The method of claim 16, wherein said removing of the fumes from the layer on the first substrate and said removing of the fumes from the layer on the second substrate each comprises generating only one stream of suction along an axis substantially perpendicular to the substrate on which the layer is disposed.

23. The method of claim 22, wherein said scanning of the layer on the first substrate and said scanning of the layer on the second substrate each comprises producing two streams of heated gas at opposite sides of the one stream of suction.

24. The method of claim 16, wherein said scanning of the layer on the first substrate and said scanning of the layer on the second substrate each comprises directing only one stream of heated gas onto the layer along an axis that intersects the substrate at an acute angle, and said removing of the fumes from the layer on the first substrate and said removing of the fumes from the layer on the second substrate each comprises generating only one stream of suction along an axis that intersects the substrate at an acute angle, said axes being substantially symmetrical about an axis extending substantially perpendicular to the substrate.

25. A baking apparatus comprising:
a stage configured to support a substrate;
at least one gas injector;
a gas supply section including a gas supply pipe connected to the gas injector, and a heater, wherein gas can be supplied to the gas injector through the gas supply pipe and heated by the heater, and the gas injector and the stage are movable relative to one another such that a substrate supported by the stage can be scanned with heated gas expelled by the gas injector, whereby a layer on the substrate can be baked; and
a vacuum system including a vacuum head, and a vacuum pump connected to the vacuum head so as to generate suction within the suction head, the vacuum head being positionable relative to the stage such that suction created in the vacuum head by the vacuum pump can remove fumes emanating from a layer on a substrate supported by the stage.

26. The baking apparatus of claim 25, wherein the gas injector is disposed above the stage and extends longitudinally in a first horizontal direction, and the gas injector is movable relative to the stage in a second horizontal direction substantially perpendicular to the first horizontal direction.

27. The baking apparatus of claim 26, wherein the gas injector has an injection nozzle that defines an opening in the form of a slit through which the heated gas is expelled, the slit extending in the first horizontal direction.

28. The baking apparatus of claim 27, wherein the gas injector includes a housing and a baffle plate extending horizontally in the housing, the baffle plate having a plurality of through-holes through which the heated gas flows to the injection nozzle.

29. The baking apparatus of claim 28, wherein the vacuum head extends parallel to the gas injector.

30. The baking apparatus of claim 27, wherein the vacuum head is fixed in position relative to the gas injector in the apparatus.

31. The baking apparatus of claim 25, wherein the gas supply section further comprises a storage container to store the gas, and a flow control valve disposed in the gas supply pipe, and wherein the gas supply pipe connects the storage container and the gas injector, and the heater is disposed relative to the gas supply pipe so as to heat the gas flowing through the gas supply pipe.

32. The baking apparatus of claim 31, wherein the gas supply section further comprises at least one filter disposed in-line with the gas supply pipe between the storage container and the heater.

33. The baking apparatus of claim 31, and further comprising:
a temperature sensor positioned in the apparatus to sense the temperature of the gas heated by the heater; and
a controller operatively connected to the temperature sensor, the heater, and the flow control valve to control the output of the heater and the degree to which the flow control valve is open on the basis of the temperature sensed by the temperature sensor.

34. The baking apparatus of claim 25, wherein the stage has a horizontal upper surface dedicate to support a substrate, and further comprising a driving mechanism operatively connected to one of said stage and said at least one gas injector so as to move said one of said stage and said at least one gas injector horizontally.

35. The baking apparatus of claim 34, wherein the gas injector extends longitudinally in a first horizontal direction, and the driving mechanism is operative to move said one of said stage and said at least one gas injector horizontally in a direction perpendicular to said first direction.

36. The baking apparatus of claim 35, wherein the vacuum head extends longitudinally parallel to the gas injector.

37. The baking apparatus of claim 36, wherein the vacuum head is fixed in position relative to the gas injector.

38. The baking apparatus of claim 34, wherein said at least one gas injector consists of a single gas injector, and the vacuum head includes a first suction member and a second suction member disposed on opposite sides of the gas injector.

39. The baking apparatus of claim 38, wherein the gas injector, the first suction member and the second suction member are oriented to expel a stream of heated gas, to generate a first stream of suction, and to generate a second stream of suction, respectively, that each flow substantially perpendicular to the upper surface of the stage.

40. The baking apparatus of claim 38, wherein the gas injector is oriented to expel a stream of heated gas that flows substantially perpendicular to the upper surface of the stage, and the first suction member and the second suction member are oriented to generate first and second streams of suction, respectively, the first stream of suction flowing along a first axis that intersects the upper surface of the stage at an acute angle, the second stream of suction stream flowing along a second axis that intersects the upper surface of the stage at an acute angle, and the first axis and the second axis being substantially symmetrical about an axis extending substantially perpendicular to the upper surface of the stage.

41. The baking apparatus of claim 34, wherein said at least one gas injector comprises a first gas injector and a second gas injector disposed on opposite sides of the vacuum head.

42. The baking apparatus of claim 41, wherein the vacuum head is oriented to generate a stream of suction that extends along an axis substantially perpendicular to the upper surface of the stage, the first gas injector and the second gas injector are oriented to expel first and second streams of heated gas, respectively, the first stream of heated gas flowing along a first axis that intersects the upper surface of the stage at an acute angle, the second stream of heated gas flowing along a second axis that intersects the upper surface of the stage at an acute angle, and the first axis and the second axis being substantially symmetrical about an axis extending substantially perpendicular to the upper surface of the stage.

43. The baking apparatus of claim 34, wherein the gas injector is oriented to expel a stream of heated gas flowing along a first axis that intersects the upper surface of the stage at an acute angle, the vacuum head is oriented to generate a stream of suction flowing along a second axis that intersects the upper surface of the stage at an acute angle, the first axis and the second axis being substantially symmetric about an axis extending substantially perpendicular to the upper surface of the stage.
